(19) United States
(12) Patent Application Publication
(10) Pub. No.: US 2004/0249719 A1
(43) Pub. Date: Dec. 9, 2004

(54) Customer decision support at point-of-sale

(76) Inventor: David Urpani, Brighton (AU)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/297,188

(22) PCT Filed: Jun. 1, 2001
(86) PCT No.: PCT/AU01/00652

(30) Foreign Application Priority Data
Jun. 1, 2000 (AU) PQ 7900

(51) Int. Cl. G06F 17/60

(52) U.S. Cl. 705/26

(57) ABSTRACT

A method of facilitating the selection of a purchase item, comprising determining objective information (400) about a user from which the purchase item, from among a plurality of purchase items, can be selected; determining a price sensitivity (410) for the purchase item; and if the price sensitivity is over a specified amount, selecting the purchase item based on said objective information and price alone, and otherwise determining additional subjective preference information (440) and selecting the purchase item based on said additional subjective information in addition to said objective information and said price sensitivity.

The present invention relates generally to methods of facilitating the selection of goods and/or services, and in particular to automated methods of providing customer decision support for facilitating this selection.

When multiple purchase item options are available, customers often need to select one purchase item from among the plurality of options. The selection process, and functions that are used to carry out the selection process, is often called customer decision support or “CDS”. Customer decision support can be carried out over many different channels or media. One popular channel, however, is an information network such as the Internet.

Search engines, price scanning engines, on-line catalogs, and other engines have been used for customer decision support over the Internet. The online catalog was an early type of sale and decision over the Internet. The online catalog operates analogously to a paper catalog. However, it allows selecting different items and automatically purchasing the items using the Internet channel. Improvements to this system became more automatic, more proactive, and more customer centric. However, as the number of options increases, the decision may become more difficult.

There currently exists a need to facilitate the selection of goods and/or services in a customer centric yet simple manner.

There also exists a need to provide a method of facilitating the selection of goods and/or services that ameliorates or overcomes one or more problems of known selection facilitation methods.

In order to assist in arriving at an understanding of the present invention, a preferred embodiment is illustrated in the attached drawings. However, it should be understood that the following description is illustrative only and should not be taken in any way as a restriction on the generality of the invention as described.

In the drawings:

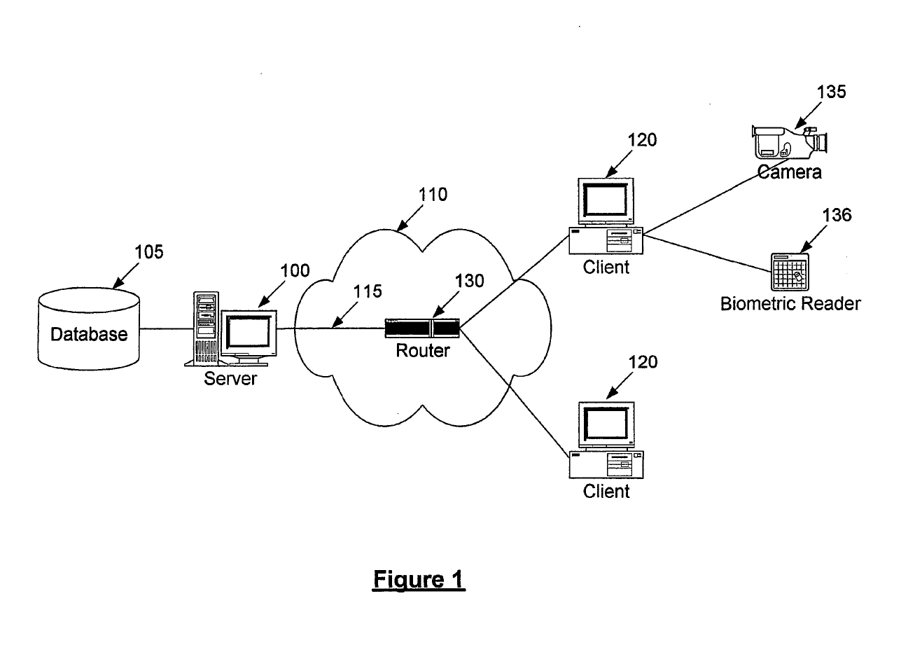

FIG. 1 is a schematic diagram illustrating a first implementation of a customer decision support system for facilitating the selection of a purchase item in accordance with the present invention;

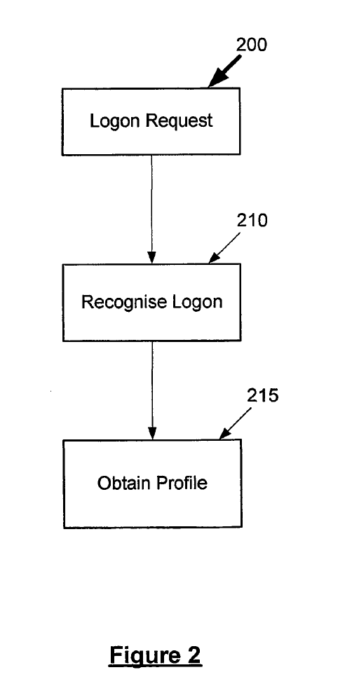

FIGS. 2 to 7 are flow charts illustrating the functionality performed by the customer decision support system of FIG. 1; and

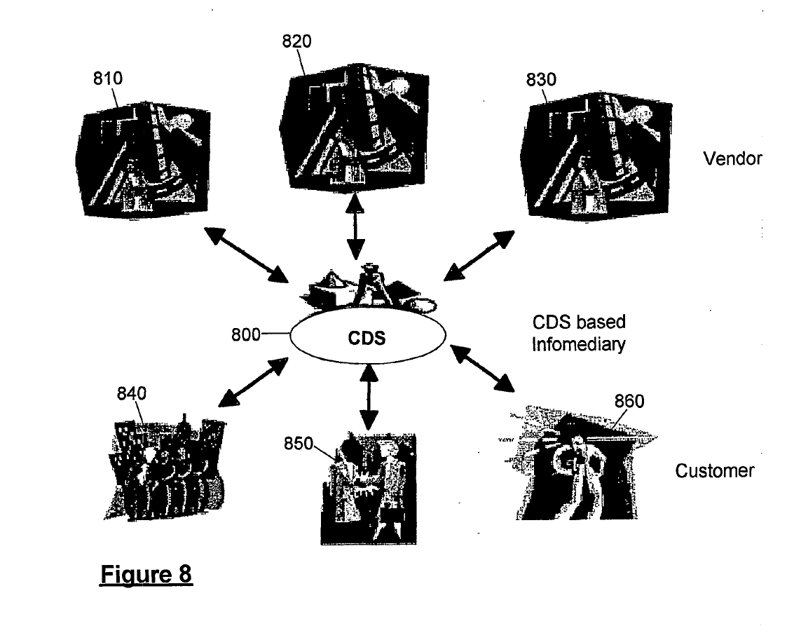

FIGS. 8 to 13 represent various implementations of the customer decision support system shown in FIG. 1.

A method of facilitating the selection of a purchase item, comprising:

determining objective information about a user from which the purchase item, from among a plurality of purchase items, can be selected;

determining a price sensitivity for the purchase item; and

if the price sensitivity is over a specified amount, selecting the purchase item based on said objective information and price alone, and otherwise determining

additional subjective preference information and selecting the purchase item based on said additional subjective information in addition to said objective information and said price sensitivity.

Another aspect of the present invention provides a method for facilitating the selection of a purchase item, comprising:

determining information about a plurality of said purchase items;

rating each of said plurality of purchase items according to a plurality of different rating benchmarks; and

allowing users to set a value for said purchase items using any of said different rating benchmarks.

Yet another aspect of the present invention provides a method for facilitating the selection of a purchase item, comprising:

requesting factual information about a user;

obtaining subjective information from the user, about the users subjective preferences, said obtaining including using information about others like the user as determined from said factual information to obtain said subjective information; and

Using both said factual information and said subjective information to select the purchase item from a plurality of said purchase items which are available.

A still further aspect of the present invention provides a method of facilitating the selection of a purchase item, comprising:

determining a plurality of purchase items to be compared;

determining features of each of the purchase items, and defining standardized indicia representing the features of the purchase items, and defining said features of said products associated with said standardized indicia; and

automatically associating said features of said products with a database.

A further aspect of the present invention provides a method of facilitating the selection of a purchase item, comprising:

forming a database of information about a plurality of purchase items to be compared;

first using a question tree to determining objective information about the user who is comparing the plurality of purchase items;

second using said question tree to obtain preference information about said user;

wherein said first and second using comprises adaptively determining an order of asking questions in the question tree.

Another aspect of the present invention provides a method of selecting purchase items from among a plurality of purchase items, comprising:

obtaining information about the plurality of purchase items;

obtaining information about the user who will be selecting between the plurality of purchase items;

determining questions to select between the plurality of purchase items; and

helping the user in answering said questions based on said information about the user.

Yet another aspect of the present invention provides a customer decision support system for facilitating the selection of a purchase item, the system comprising:

a first server computer storing a first database of purchase item information obtained from one or more vendors relating to a plurality of said purchase items, a user interface program and a customer decision support program for performing a method according to any one of the preceding claims, the server computer being accessible by one or more users via a communications network.

Customer decision support includes the science of translating the customer's need or desire into a product that meets those needs or desires. Customer relationship management is the flip side of customer decision support. Customer relationship management may determine customer satisfaction after the sale has been completed. “Post purchase evaluation” can be used to determine the customer's satisfaction with the product that they actually purchase. This provides data that can be used to attempt to improve the system for others.

The basic hardware forming the basic setup of the present invention is shown in FIG. 1. A server computer 100, at a central location, stores a database of information, as well as a user interface program, a main program which can run a network interfacing program, such as a web browser and a customer decision support program. The server computer 100 is connected to a network 110, which connects the server 100 to a plurality of client computers 120. The network can be the Internet, or can be any other network that allows an exchange of information. For example, in one embodiment, the network 110 may be a dedicated dial-up or LAN network. The network comprises at least an information line 115, and a router 130. The information line 115 can be a telephone line and the router 130 can be the Internet backbone, for example. The server computer 100 runs a routine that is described with reference to the flow chart of FIG. 2.

Many client computers can be connected to the server 100. Client 120 is shown at a remote location.

The client computer 120 can be any computer which is capable of running a network interfacing program such as a web browser. In addition, the client computer can have various peripherals attached thereto. These peripherals can include, for example, a camera 135, a biometric reader 136, a speech synthesiser, a microphone and the like.

In operation, each of the client computers is driven to run the specified routine under control of the computer server 100.

According to the present application, the user enters an initial profile, either over the network, e.g., the Internet, or in person. The profile may be supplemented over time.

The specified routines run by both the client and customer decision support program stored by the server computer are described throughout this application. The client part(s) of the routine, may have multiple clients requesting information from the same server. Any multitasking system can be used to handle these requests.

FIG. 2 shows the operation. At 200, the client computer 120 transmits a logon request to the server computer. This can be done by entering a user name and password. Alternatively, biometric information can be obtained from the part 136 and sent to the server computer 100. The biometric information part uniquely identifies the user, and hence serves as at least part of the log-in.

At step 210, the server computer recognizes an accepted logon corresponding to an authorized user. In response to this detection, the server obtains the pre-stored profile of the user at 215. The pre-stored profile includes information that was entered to enrol the person into the system and also information from previous system accesses. Each time the user accesses the system, additional information can be added to the pre-stored profile and stored in the main database 105 in server 100.

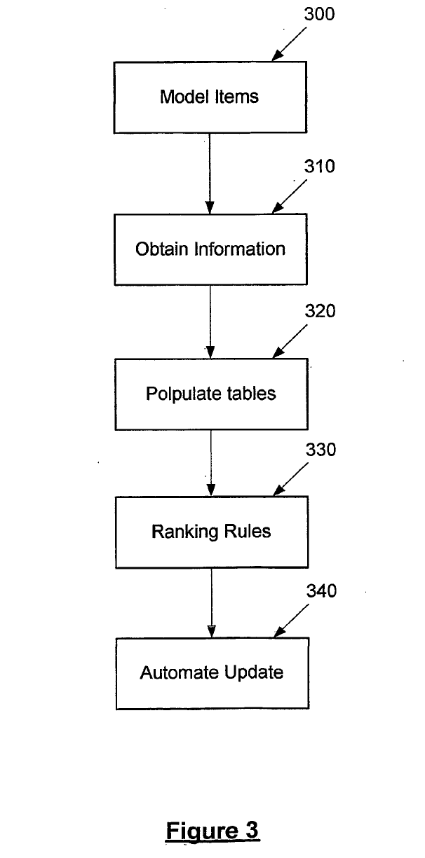

The CDS operation starts by forming an item database. The items in the database can be products or services or any other commodity that can be evaluated. The formation of the item database is described with reference to the flow chart of FIG. 3.

The operation begins by obtaining information indicative of a collection of items that will be compared by the system. At 300, each item to be compared is modeled according to specified criteria. The “purchase items” can be products or services, or any other item which is placed for sale and purchased by an end user.

According to one mode of operation, items are evaluated to determine the features of the items. For example, one preferred aspect of the present system is for use in comparing different kinds and/or plans of health insurances. Another preferred use may be for purchasing automobiles or automobile insurance policies. Other preferred uses are described herein.

The different health insurances are compared based on price and features. Features of health insurance may include, for example, the kind of coverage, deductible for the coverage, and kinds of care which are included in the plan. Each of the different features is defined and rated.

At 310, information about the product is obtained based on the modeling at 300. The modeled product may be ranked or otherwise evaluated, to form a set of database tables. In a specified mode, the features are defined as data associated with standard indicia, such as XML tags. All possible features of all of the different insurance policies define the entire universe of the XML, tags. This set of possible tags forms a standard for describing each of the policies.

For example, a policy could be defined as multiple XML tags, with numeric or other values associated with each tag. For an example, if physical therapy is available at a cost, the XML tag could say

<Physical_therapy>Y

or

<Physical_therapy>$200 deductable,

to indicate it's availability or the charges or features associated with the tag.

By defining the item in terms of standardized parts, each product is automatically put into a standardized form. New products can be automatically added to the database if the information about the products is provided in the same tagged form. This again can automatically update the channel, e.g. the website that is hosting this information. While tags, and specifically XML tags, may be preferred, any other standardized way of defining the information can be used, such as metatags, or other ways of standardized marking.

These tables may be populated with information defined as the XML tags. Since the XM tag may be uniform, the product makers, or third party vendors may produce the XML tags for use with the system.

At 320, the tables are populated based on the information that is obtained at 310. The tables can be automatically populated based on the XML tags. Each XML tag may instruct placing information in a specified position within the table. 330 represents ranking rules which are used for ranking. Different business rating rules may be used for different purposes. For example, different kinds of ratings and rating schemes can be used. One rating scheme may be based on the satisfaction of other customers with the specified product. Another rating can be observations of experts about the features of the policy. Yet another rating may be an independent rating service, such as the consumer reports type service. For instance, insurance companies may also be rated, e.g. one insurance company may be the number one rated insurance company. Another rating may be based on the financial stability of the insurance company. Independent expert opinions may also be used.

A number of different business models can be established for each product or category of the product. Each of these business models set a benchmark for the product. There may be multiple benchmarks as described above. This enables different kinds of comparisons, e.g., a first comparison with what other consumers think, and a second comparison with what experts think.

Information about the different rating schemes, e.g., about customer rating schemes, expert rating schemes and independent rating schemes, may be part of the information at 330. By providing multiple rating schemes, the user is later allowed to select either a single rating scheme, or multiple rating schemes which may be averaged according to specified entered percentages 330 may include a benchmark or a set of benchmarks.

Later in the CDS process, features are rated based on their relationship to the benchmark or benchmarks. This is done using an engine described herein.

The information in the product database can be updated as needed. By the use of standardized tags, such as XML, tags, the information can be automatically updated at step 340.

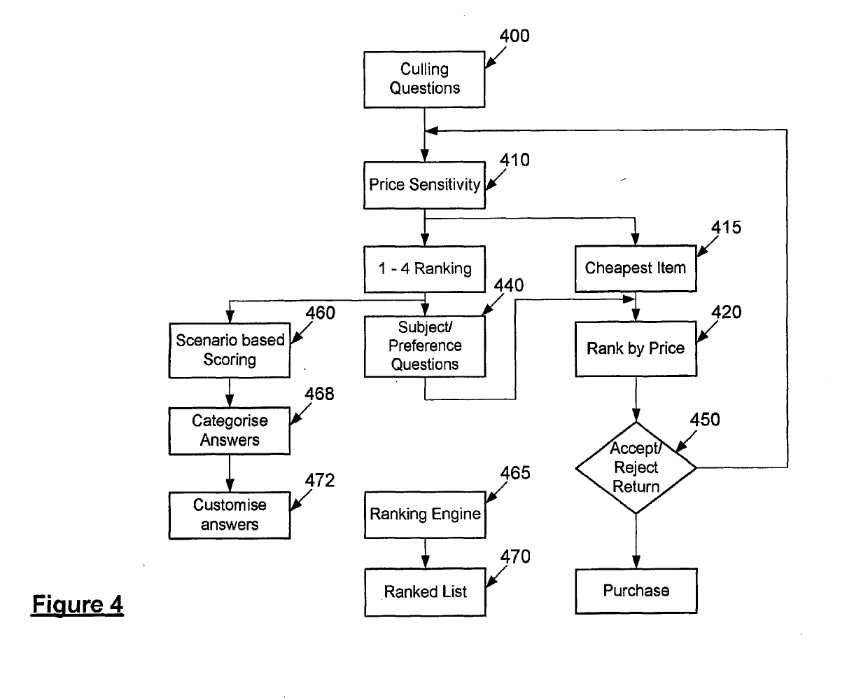

The product is selected by following the flow that is outlined in FIG. 4, to gather individual and preference data from the user and use the data in conjunction with the product database.

In this embodiment, the initial selection gathers the data based on a question tree which includes “culling questions” at 400. The culling questions may obtain objective information which is specific to the user and based on factual information about the user. Culling questions may ask factual data, demographic data, and other information which is more factual than subjective.

The contents of the question tree can be formed based on data from sales experts which indicates the kinds of details that may be necessary in order to select a health insurance policy. For example, experts may be consulted about the different kinds of factors that might be relevant or important for selecting health insurance. This can be based on knowledge of the market or knowledge of the pricing structure for knowledge about how to sell. The question tree can be dynamically created based on data about how one would normally sell health insurance.

Example culling questions may include whether the user is male or female, family or single, and the place where they live. Culling questions may be demographic and similar questions which narrow down the options of applicable products.

The culling questions provide a factual basis for selecting a product. After that subjective information is obtained, the system questions price sensitivity at 410. Price sensitivity is a first subjective question which is asked. The price sensitivity may form an initial cutting down of product selections. Price may be the primary concern that a user has. For example, if the user indicates that price is the primary consideration, then all other preference questions can be avoided. If the user says, for example, “give me the cheapest possible item” at 415, then the operation proceeds to rank by price at 420 thereby bypassing the rest of the preference questions.

415 and 425 show the different ways that price sensitivity can be used. If the user selects a price sensitivity point in a numerical scale between ‘not as important’ (here price sensitivity level 1), and very important but not the only factor; (here price sensitivity level 4), then the price sensitivity becomes a ranking factor, which is considered with all other factors. However, if the user selects price sensitivity level 5, meaning that price sensitivity is of paramount importance, then all other ranking features are defeated and an immediate rank by price is carried out at 420. Higher price sensitivity may override all other preference determinations, that would otherwise be queried.

Otherwise, 440 begins the preference questions, to obtain subjective information from the user. As compared with the culling questions which are factual, the preference questions are subjective, being based more on preferences, i.e. what the user wants in a selected item. The preference questions may be answered either yes or no, or may be “fuzzy” questions which require the user to answer according to a numerical scale. Using the example of health insurance, the user may indicate whether they want the policy to cover physical therapy, chiropractors or other optional services. Each of these optional services changes the universe of health insurance policies that will fit the individual needs of the user.

A ranking engine shown as 465 considers each of the customer preferences, and scores for the customer preferences, for each criteria (e.g., for each tag), and for each way of scoring. The ranking engine can be written as:

$${Score}_{″} = Σ \vec{W} \cdot \vec{S}$$

where, n is the customer preferences, W is the weighting for the customer preferences, and S is the score for the customer preferences.

At 470, based on the evaluation data from the results of the ranking, the system provides a ranked list shown in FIG. 5. The ranked list includes the results of the CDS, here Policy 1, policy 2, and each of the desired features and cost. Each item can be selected, for further options, such as purchase. Each may also include additional information such as public relations or advertising messages. The ranked list may return different policies which meet the user specified criteria. In addition, however, certain suppliers may pay extra to highlight their insurance policies in a specified ranked list or only in certain ranked lists. For example, an insurance company may desire more customers who meet certain criterion, e.g., a certain demographic class. The insurance company may therefore include extra bonuses or other incentives targeted to those specific groups. 510 shows an advertising message that could be added to specified results, for example.

Public relation messages may include sales messages which extol the virtues of the specified product. They may also include, however, incentives such as offers for free or discounted products in return for subscribing.

At 450, the system allows the user to purchase the insurance (“accept”). This can be done by accepting payment details, and binding the user to an insurance policy.

If the user is not totally satisfied, or has decided to change or investigate some features, flow returns to a previous step. The flow may return to the preference questions. The user can re-enter any of their answers. Since the culling questions are factual, it may be unlikely that the user would change these, and more likely that the answers to the price sensitivity and/or preference questions would be changed. However, all changes are accepted.

An alternative way of forming the policies is to present the different factual information and desires to suppliers, and allow those suppliers to bid on the insurance package for these criteria. This can be done in real-time, or can provide a delayed response back to the 5 user. This bidding system may allow the companies to adaptively change their demographic or other makeup by providing certain incentives at certain times.

The system may be used for other products. Examples of the other products include vacation selection including hotel and aircraft, immediate delivery such as digital TV, Internet service providers, auto insurance and auto purchasing, and others described herein.

Additional features can also be provided. One such feature is scenario based scoring shown as 460. After the culling questions, the system statistically knows about the user and the user's characteristics. Scenario based scoring, as shown in 460, can be used to help the customer's decision processes. The scenario based scoring can select and suggest choices for user based on others like the user. This can be based on choices that others who were like the person currently making the decision, have selected. These choices can be suggestions or defaults. Suggestions can be made based on statistics for others like the person making the choices, e.g. their “peer” group. Information about users demographic characteristics, including users location, age, family size or like information, can be used. For example, physical therapy may never be needed or may be needed statistically infrequently, in a specified age group buying health insurance. Therefore, the scenario based scoring system can suggest that perhaps this user does not need this kind of coverage; either when asked or as a suggestion when the user makes a selection that seems contrary to its does physical information stored within the system.

Another's aspect of scenario based scoring allows the user to question what peers have done in a specific situation. This can be done automatically, for example, by setting defaults on answers on the decision tree.

The above has described scenario based scoring based on peers. Scenario based scoring can also use preferences based on lifestyle. The information used to make the lifestyle choice is still factual, but is less about the users subjective characteristics, and is more about the user's preference characteristics. For example, the peer approach to scenario based scoring looks at what the user does when each question is asked. When the user asks a question, scenario based scoring allows the user to find out what others like him have done. Another example, however classifies the user based on characteristics of their lifestyle or occupations. Example classes may include pilot, computer programmer, driver, diver or the like. Any of these scenarios may indicate what the user does for a living, what they do for hobbies, or plans to do in the future. The user can choose one of these scenarios, or may combine multiple scenarios either equally or using weighted averages.

The system translates each scenario into some information about the product. In the health insurance context, a skier may be more prone to certain injuries. In the automobile purchase context, a skier might want a four-wheel-drive vehicle with a ski rack. A computer user may be prone to sitting up straight injuries and carpal tunnel injuries. The customers are also allowed to change and choose the scenarios, allowing the system to use these scenarios to suggest certain selections.

Different users may feel more comfortable in answering questions that are presented in a different order. For example, some users may not think about certain answers is sought through other parts of the problem. A question tree may be provided which is constructed such that it can be answered in a number of different ways or the question tree may be constructed dynamically, for example. In this way, one answers only the questions that one need's to answer to get to the end of the question sequence. The system may also allow fuzzy answers such as ‘I don't know’, ‘I don’t think so’ and the like. An example occurs when shopping for consumer goods. The user may be asked details about what car they want to buy. A number of different alternatives can be provided as specified answers. One of the alternatives is a fuzzy answers such as I don't know. If the user answers “don't know” to a question about exterior color, then in interior color questions are similarly not asked. Each answer to each question is categorized at 468. When the user indicates an answer of either ‘I don't know’ or ‘I don't want to answer this question right now’, then 472 prevents other questions of the same category from being asked. If the user refuses totally to answer a question, then the recommendation can be made based on the existing data. In this way, the scoring is based on the parts of the decision tree which have been answered, and the parts that had not been answered are ignored.

In this way, the question tree is personalized, based on the way that questions are answered. This allows the question tree to operate based on the way that is most familiar to the user. The personal of limitation can include, for example, pointed entry into the question tree, questions and choices where the user's answer and do not answer, and the like.

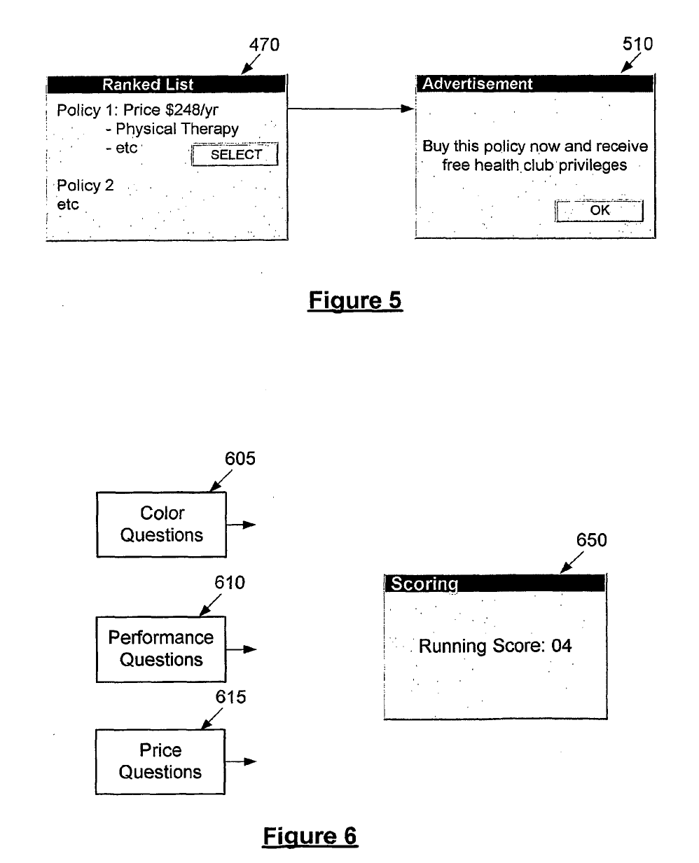

An example, shown in FIG. 6, can provide a summary screen with a number of questions or a number of question categories, each category having at least one question therein. FIG. 6 shows color questions 605 (i.e., what color product do you want), performance questions 610, e.g. what kind of motor do you want in the automobile, or what kind of features do you want on the insurance policy, price questions 615, and others. The user can click to select any of the questions or categories that they want to answer. As the user answers questions, the questions or the categories disappear. A scoring system may provide a running score of the answers shown as 650. As more questions are answered, the scoring improves.

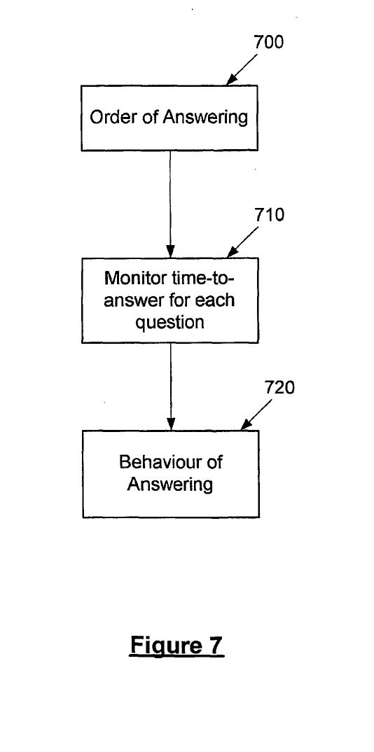

Each of the items of data in FIG. 7 can be stored as a weight associated with the question. Each weight can be used to adjust the way in which the question is answered. The weight can be used to determine the position of the question i.e. towards the beginning of the questioning or towards the end of the questioning. The weight can also be used, as described herein, to determine whether hints should be provided.

In 700, the system follows the order that the questions in FIG. 6 are answered. The questions may be re-ordered, so that they are answered in the same order the next time the user comes to the site. The user may also have the option to select “skip question for now”. For example, with an automobile, the user may not want to answer color questions until they are entirely sure of the model of car they want.

More information can be obtained by monitoring the clickstream of the user's responses, and determining the time that the user takes to answer certain kinds of questions. The TIME_TO_ANSWER can be stored as a variable associated with each question. The system can calculate which of these questions is easiest for the user to answer, and which is more difficult. The user interface can be adjusted accordingly, i.e., to include the questions which were answered first as questions at the top of the tree. The scenario based scoring of 460 can be used for those questions that take more than a specified amount of time to answer, for example. This can help with suggestions for answers to the more difficult questions.

The system can also analyze the behavior of the person at 720. For example, if the user looks at each information screen for each question, this may indicate that the user may desire more information. The user interface may therefore be customized to present the information automatically without the user absolutely asking for it. This may prevent the user from having to click on certain icons at different times. More generally, when the user follows a particular pattern of behavior, then the system should note that pattern of behavior and automatically display information which follows that pattern of behavior.

Because of the multiple different aspects of this system, the speed of response may become degraded by more and more choices and selections. An enormous number of variables may exist in this system. Therefore, according to one aspect, it each possible answer to each possible scenario is precomputed as a multidimensional matrix. The answers to each of the questions and the data formed addresses into the matrix. The matrix therefore becomes a look up table for each of the different possible alternatives. This can increase the speed of the system.

A user must have confidence in the system in order to use it. Therefore, another aspect of this system is the ability to explain the answers to a user: “explainability” some users may have blind faith in the results which are given to them by the system. Others may want those results to be explained to them. The user may ask, for example, “why is this the best preference for me”? This requires that the system trace out parts of the decision tree that were followed, and develop a narrative based on those parts that were followed. For example, the system may say “you told us that you have two children, live in Victoria, and want a moderately priced insurance policy which has the following options . . . ”. In this way, the narrative can explain how the recommendation was obtained. By doing so, the user's confidence in the recommendation can be improved. Although only a few embodiments have been disclosed in detail above, other modifications are possible. For example, although this system has been described as being used in the PC (business to consumer) context, it can also be used in the to be per business to business) context. For example, the system can be used to help a business understand its needs for example for spare parts. An example might be used in determining how many spare parts to use in aircraft engines. The user can decide how many spare parts they may need at any given time based on the expert system that is programmed into the computer. A decision tree can be built to help the user understand why certain operations due and do not occur.

The basic hardware illustrated in FIG. 1 is an example of implementation of the present invention in a stand alone system. This stand alone system is represented schematically in FIG. 8. As can be seen, the customer decision support system shown in this figure includes a first server computer 800 storing a first database of purchase item information obtained from vendors 810, 820 and 830 in the manner previously described. The first server computer 800 includes a user interface program and a customer decision support program for performing the functionality previously described in relation to FIGS. 1 to 7. The first server computer is accessible by one or more users, here represented by exemplary users 840, 850 and 860 the configuration shown in this figure represents an infomediary model, namely an application of the customer decision support system in which a single infomediary enables one or more users to select a purchase item across multiple vendors.

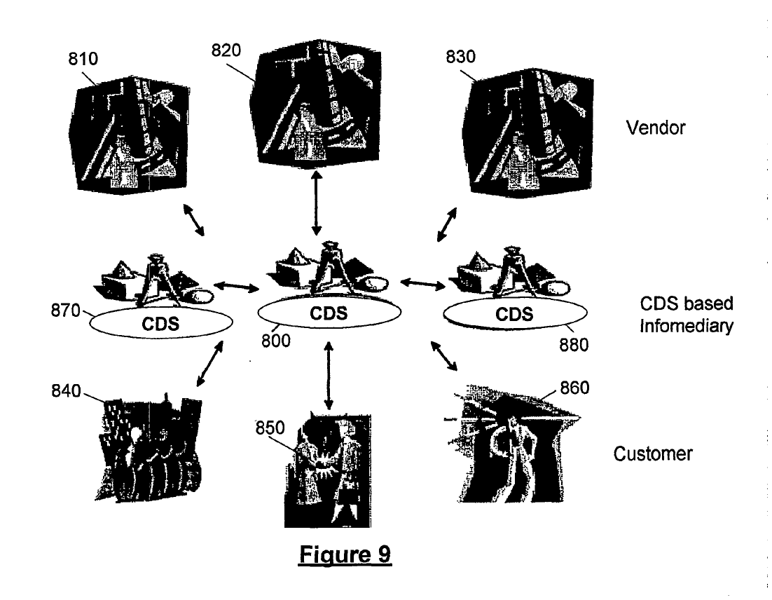

The customer decision support system may also be implemented in a networked version, thereby unbundling different types of intelligence and re-aggregating such intelligence as required. Non networked customer decision support systems create islands of knowledge, whereas networked customer support systems can create distributed knowledge that can be connected creatively up and down value chains, vertically or horizontally within organisations and industries. As shown in FIG. 9, a networked customer decision support system may include, in addition to the first server computer, additional server computers 870 and 880 each storing an additional database of purchase item information obtained from one or more of the vendors 810, 820 and 830. The first server computer 800 and the additional server computers 870 and 880 are mutually accessible via a communications network, such as the Internet, to enable the exchange of at least purchase item information and optionally user objective and subjective information. In this implementation, the server computers act as infomediaries that use a common, networked customer decision support system to collaborate with each other by sharing information, customers, fulfilment and decision support.

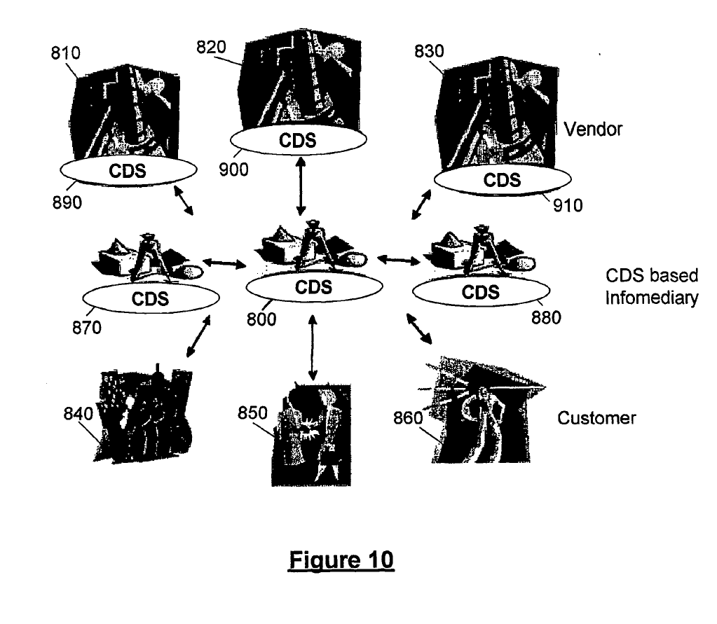

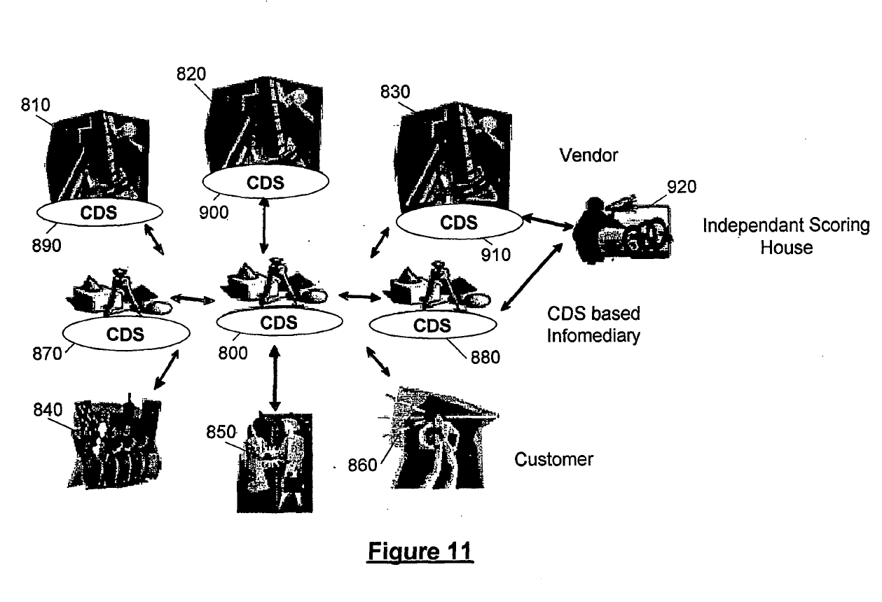

In a further implementation shown in FIG. 10, the vendors 810, 820 and 830 can be enabled by their own customer decision support technology to offer their own product sets to their own clients and to other customer decision support networked infomediaries. Accordingly, the vendors 810, 820 and 830 each maintain a vendor customer decision support computer, respectively referenced 890, 900 and 910 each storing a vendor database of purchase item information obtained from that vendor. The vendor customer decision support computers 890, 900 and 910 are accessible via a communications network, such as the Internet, to at least one of the server computers 800, 870 and 880 to provide purchase item information.

Customers concerns relating to the privacy of their subjective information, may be alleviated by the provision of an independent house that securely stores user subjective information and selectively provides such information to one or more of the customer decision support computers 800, 870, 880, 890, 900 and 910. As seen in FIG. 11, a scoring computer 920 may be provided storing a database of purchase item evaluation data or other user subjective information. The scoring computer 920 is accessible via a communications network to at least one of the server computers to selectively provide the purchase item evaluation data and other user information stored therein.

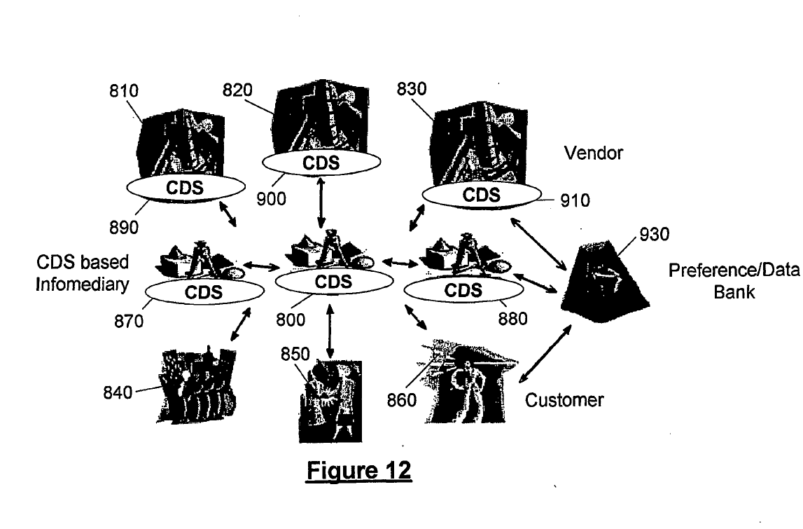

Customer objective information and subjective information may also be decoupled from the customer decision support system. As shown in FIG. 12, a user private information computer 930 may be provided, storing a database of user subjective information accessible to users and to one or more of the server computers on a selective basis. Users can benefit by not having to enter the same data on multiple vendor sites and can be projected from abuse of the data via junk mail. The user private information computer may allow vendors and customer decision support based infomediaries access to certain user preference information to provide decision support services, without allowing modification of that information. A user may decide which data is accessible to a vendor or infomediary and which data can be stored and retained by that vendor or infomediary. Decoupling of user preference information enables the protection of that information.

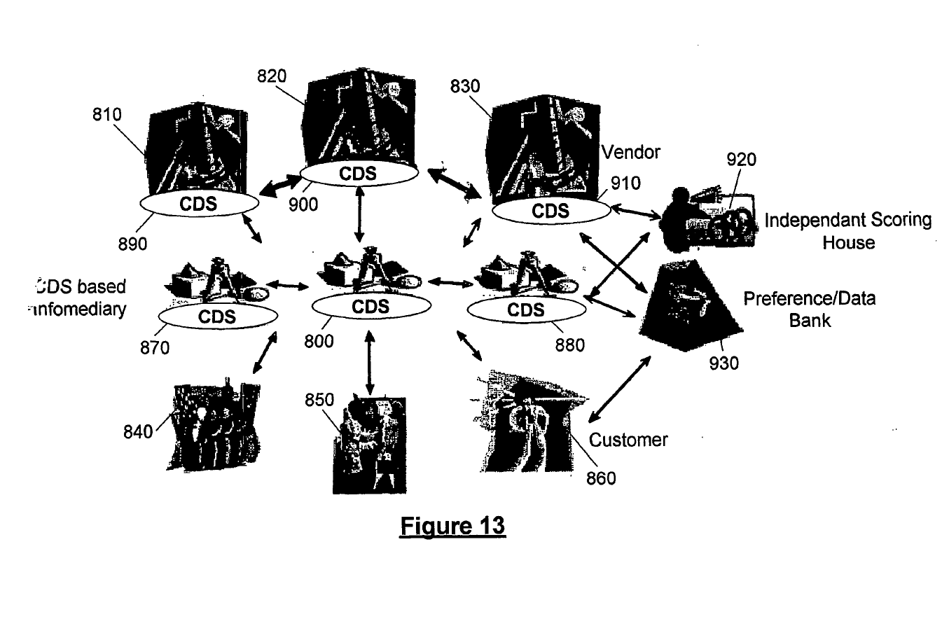

In a further implementation shown in FIG. 13, one or more of the vendor customer decision support computers 890, 900 and 910 maybe networked so as to be mutually accessible and enable the exchange of purchase item and other information. In this implementation, both vendors and infomediaries are networked and are able to exchange customer subjective and objective information as up sell and cross sell opportunities arise, thereby enabling a product vendor to sell other vendors products in a customer driven demand supported by customer decision support. Rather than lose customers if they are not competitive, vendors may receive commission payments. The overall result is a market that is “frictionless” due to product and preference information shared between customers and vendors.

It is to be understood that various modifications and/or additions may be made to the purchase item selection method and customer decision support system without departing from the ambit of the present invention as defined in the claims appended hereto.

1-63. Canceled

64. A method of facilitating the selection of a purchased item comprising the steps of:
determining objective information about a user to facilitate the selection of the purchase item from among a plurality of purchase items;
determining a price sensitivity for the purchase item;
if the price sensitivity is over a selected value, selecting the purchase item based solely on the objective information and price of the purchase item; and
if the price sensitivity is below a selected value, determining additional subjective preference information and selecting the purchase item based on the additional subjective preference information, the objective information, and the price of the purchase item.

65. The method according to claim 64 wherein the step of determining the objective information involves using culling questions.

66. A method for facilitating the selection of a purchase item comprising the steps of:
determining information about a plurality of purchase items;
rating each of the purchase items according to a plurality of different rating benchmarks; and
setting values for the purchase items using any of the rating benchmarks.

67. The method according to claim 66 wherein the values are set using a plurality of benchmarks.

68. The method according to claim 67 wherein the plurality of benchmarks are weighted according to selected criteria.

69. A method for facilitating the selection of a purchase item comprising the steps of:
obtaining selected factual information about a user;
obtaining selected subjective information from the user including information about the user's subjective preferences, wherein obtaining such selective information includes using information about the subjective preferences of individuals similar to the user based upon the factual information obtained about the user; and
selecting a purchase item from a plurality of purchase items based upon at least one of the factual information and the subjective information.

70. The method according to claim 69 wherein using information about individuals similar to the user is provided as at least one of default answers to specific questions and suggested choices of answers.

71. The method according to claim 69 wherein the factual information includes information about at least one of the user's demographic characteristics and the user's lifestyle.

72. The method according to claim 71 wherein the demographic characteristic information includes information about at least one of the user's location, age, and family size and the user's lifestyle information includes information about the user's occupation.

73. A method of facilitating the selection of a purchase item comprising the steps of:
selecting a plurality of purchase items to be compared to each other;
determining features of each of the purchase items;
defining standardized indicia representing the features of each of the purchase items;
defining the features of the purchase items associated with the standardized indicia; and
storing the features of the purchase items associated with such standardized indicia in a database.

74. The method according to claim 73 wherein the standard indicia are XML tags.

75. The method according to claim 73 further comprising the step of allowing a user to select at least one purchase item feature based on information stored in the database.

76. The method according to claim 73 wherein the purchase items are insurance policies and the indicia include types of coverage that are allowed by the insurance agencies.

77. The method according to claim 73 wherein the purchase items are automobiles and the indicia include options available on the automobiles.

78. The method according to claim 73 further comprising the steps of:
determining a plurality of ranking rules for ranking the purchase items, wherein each ranking rule uses a different ranking scheme; and
allowing a user to select purchase item features based on information in the database and the ranking rules.

79. The method according to claim 78 further comprising the step of allowing the user to select which ranking rules are used.

80. The method according to claim 79 further comprising the step of allowing the user to determine a relative weighting scheme for the ranking rules.

81. The method according to claim 73 further comprising the steps of:
defining the features of additional purchase items using the standardized indicia; and
storing such features in the database.

82. A method of facilitating the selection of a purchase item comprising the steps of:
obtaining objective information about a user who is comparing a plurality of purchase items by adaptively determining an order of asking questions; and
obtaining preference information about the user by adaptively determining an order of asking questions.

83. The method according to claim 82 further comprising the step of using at least one of the objective information and the preference information to evaluate the plurality of purchase items and create evaluation data.

84. The method according to claim 83 further comprising the step of obtaining price sensitivity values for each of the purchase items.

85. The method according to claim 84 further comprising the step of nonlinearly weighting price sensitivity values for each of the purchase items.

86. The method according to claim 85 wherein if price sensitivity value for a purchase item is above a specified value, then the price sensitivity value is the only factor used in the selection of the purchase item, and if the price sensitivity value for a purchase item is below such specified value, then the price sensitivity value is one factor used in the selection of the purchase item.

87. The method according to claim 82 wherein the preference information is obtained by having the user answer the questions according to a numerical scale.

88. The method according to claim 83 further comprising the step of creating a ranked list of the evaluation data.

89 The method according to claim 82 further comprising the steps of:
obtaining selected information about individuals similar to the user based on the objective information obtained about the user; and
selectively rating such information about individuals' similar to the user.

90. The method according to claim 89 wherein the rating information about individuals similar to the user comprises using at least one of statistical data related to choices made by individuals similar to the user or providing suggestions based on choices made by individuals similar to the user.

91. The method according to claim 91 wherein the suggestions are provided when the user makes a selection that is determined to be improper.

92. The method according to claim 82 further comprising the steps of:
obtaining information about lifestyle of the user by adaptively determining an order of asking questions;
creating a lifestyle category based on such information; and
selectively rating the lifestyle category.

93. The method according to claim 92 wherein the lifestyle category includes a package of specified options for the purchase item.

94. The method according to claim 82 wherein adaptively determining the order of questions to be asked comprises monitoring an order of answering the questions and providing the questions in the order determined by the monitoring.

95. The method according to claim 82 wherein adaptively determining the order of questions to be asked comprises determining a time to answer the questions and using the time to answer to select the order of the questions.

96. The method according to claim 95 wherein questions which have a longer time to answer are placed later in the order of questions.

97. The method according to claim 82 wherein adaptively determining the order of questions to be asked comprises analyzing the behavior of a user answering the questions.

98. The method according to claim 97 wherein analyzing the behavior comprises determining if the user requests more information about the questions and providing more information in response to such request.

99. The method according to claim 82 further comprising the step of maintaining response to questions asked and providing explanations for such responses.

100. A method of selecting a purchase item from among a plurality of purchase items comprising the steps of:
obtaining selected information about the plurality of purchase items;
obtaining selected information about the user who will be selecting the purchase item;
prompting the user to answer questions to facilitate the user in the selection of the purchase item; and
assisting the user in answering the questions based on the selected information obtained about the user.

101. The method according to claim 100 wherein assisting the user to answer the questions comprises providing default answers to the questions wherein such default answers are based upon the selected information obtained about the user.

102. The method according to claim 100 wherein assisting the user to answer the questions comprises providing suggestions to the user for answering the questions wherein such suggestions are based upon the selected information obtained about the user.

103. The method according to claim 100 further comprising the steps of:
determining whether an answer is incorrect based on the information obtained; and
notifying the user that the answer is incorrect.

104. The method according to claim 100 further comprising the step of comparing the selected information obtained about the user with information about individuals similar to the user.

105. The method according to claim 100 wherein the selected information obtained about the user includes information about the lifestyle of the user.

106. The method according to claim 100 wherein the step of obtaining selected information about the purchase items comprises modeling the purchase items according to selected characteristics about the purchase items.

107. The method according to claim 106 wherein the selected characteristics are modeled according to standardized items.

108. The method according to claim 107 wherein the standardized items are XML data tags.

109. A customer decision support system for facilitating the selection of a purchase item comprising:
means adapted to obtain selected information about a plurality of purchase items from at least one vendor;
first server means adapted to store the selected information about the purchase items;
a customer interface adapted to receive information from the customer; and
customer decision support means adapted to facilitate a customer in the selection based on the information received from the customer and the selected information about the purchase items, wherein the server means is accessible by at least one customer via a communications network.

110. The system according to claim 109 further comprising:
at least one additional server means to store the selected information about the purchase items; and
means adapted to exchange the selected information about the purchase items between the first server means and the at least one additional server means.

111. The system according to claim 110 further comprising:
at least one vendor support means adapted to store selected information obtained from at least one vendor about the purchase item; and
means adapted to exchange the selected information about the purchase items between the at least one vendor support means and at least one of the first server means and the at least one additional server means.

112. The system according to claim 111 further comprising:
means adapted to evaluate the selected information about the purchase items and create evaluation data;
evaluation storage means for storing the evaluation data; and
means adapted to exchange information between the evaluation storage means and at least one of the first server means, the at least one additional server means, and the at least one vendor support means.

113. The system according to claim 112 further comprising:
customer private information storage means adapted to store selected user subjective information; and
means adapted to exchange information between the customer private information storage means and at least one of the first server means, the at least one additional server means, the at least one vendor support means, and at least one customer.
